(19) United States
(12) Patent Application Publication
(10) Pub. No.: US 2005/0041214 A1
(43) Pub. Date: Feb. 24, 2005

(54) Liquid-crystal projector

(76) Inventor: Satoru Kawaai, Saitama (JP)

Correspondence Address: Arnold International, P.O. Box 129, Great Falls, VA, 22066, US

(21) Appl. No.: 10/913,344

(22) Filed: Aug. 9, 2004

(30) Foreign Application Priority Data
Aug. 20, 2003 (JP) 2003-296492

(51) Int. Cl. G03B 21/00

(52) U.S. Cl. 353/31

(57) ABSTRACT

An illuminating light from a light source is separated into a beam containing red and green light and a beam containing blue light and UV rays by a dichroic mirror. The blue light is reflected by a first PBS and enters to a liquid-crystal display corresponding to the blue light. On the other hand, the beam containing the red and green light is separated into the red light and the green light by a polarization rotator and a second PBS, and the separated red and green lights enter to liquid-crystal displays corresponding to each color light. Blue, green and red image lights emitted from the respective liquid-crystal projector are composed by a composite prism. An UV cut filter is disposed between the dichroic mirror and the first PBS. The UV cut filter removes the UV rays from the optical path of the blue light, by absorbing the UV rays.

### BACKGROUND OF THE INVENTION

1. Field of the Invention

The present invention relates to a liquid-crystal projector. More particularly, the present invention relates to a three-panel type of liquid-crystal projector having three liquid-crystal displays corresponding to red, green, and blue light respectively.

2. Description Related to the Prior Art

As disclosed in Laid-Open U.S. patent application Ser. No. 2003/0189676, the three-panel type liquid-crystal projector having three liquid-crystal displays corresponding to the red, green, and blue color light respectively, which composes image lights modulated by each liquid-crystal displays and projects the composed image light to the screen, is well known. In this liquid-crystal projector, an illuminating light emitted from a light source is separated into the red, green, and blue lights, separeted each color lights are emitted into the corresponding liquid-crystal displays, and the image lights emitted from each liquid-crystal display are composed. In addition, a dichroic mirror to transmit the blue light, reflects the green and red light to a polarizing beam splitter (hereinafter PBS), where the green light and the red light are separated. Just in front of the PBS, for example a polarization rotator having wavelength selectivity, which changes polarization state of either the green light or the red light by rotating the plane of polarization 90 degrees, is disposed. Accordingly, the green light and the red light are separated such that either of the green light or the red light entered to the PBS passes through a polarizing film of the PBS, and the other is reflected by the polarizing film.

In the general liquid-crystal projector, the illuminating light contains ultraviolet rays (hereinafter UV rays), in addition to the blue light, the green light, and the red light. The polarization rotator having wavelength selectivity tends to be deteriorated by the UV rays. Accordingly, life time of the optical system is determined by that of the polarization rotator. In the above-described liquid-crystal projector of Laid-Open U.S. patent application Ser. No. 2003/0189676, the blue light which wavelength band is overlapped with that of the UV rays is separated at first from the green light and the red light, such that the UV rays are prevented from entering an optical path of the green light and the red light.

However, even if the UV rays are prevented from entering the optical path of the green light and the red light, the UV rays still enter an optical path of the blue light. In optical components which constitute the optical system, there are many components having low resistance to UV rays, in addition to the polarization rotator which described above. Accordingly, there is necessity of preventing the optical element arranged in the optical path of the blue light from deteriorating by effect of the UV rays, for lengthen the lifetime of the optical system.

### SUMMARY OF THE INVENTION

A main object of the present invention is to provide a liquid-crystal projector whose optical element is prevented from deterioration by effect of UV rays.

Another object of the present invention is to provide a liquid-crystal projector whose optical system has long lifetime.

In order to achieve the object and the other object, the liquid-crystal projector of the present invention comprises a light source for emitting white light which contains red, green and blue light, and UV rays, liquid-crystal displays which modulate the red, green and blue light respectively, and a color separating and composing means which separates the white light into the red, green and blue light, carries out the red, green and blue light to the corresponding liquid-crystal display, and composes the red, green and blue light which are emitted by the respective liquid-crystal displays. The color separating and composing means includes a first color separating means which separates the white light into a beam containing the red and green light and a beam containing the blue light and the UV rays, a second color separating means which separates the beam containing the red and green light into the red light and the green light, and an UV rays removing means which removes the UV rays from the beam containing the blue light and the UV rays.

In a preferable embodiment of the present invention, it is arranged in order of the first color separating means, the UV rays removing means, and the liquid-crystal display, along the optical path of the blue light, from the light source side. The color separating and composing means further includes at least one optical component which reflects or transmits the blue light separated by the first color separating means, the optical component is disposed between the UV rays removing means and the liquid-crystal display, or behind the liquid-crystal display.

The color separating and composing means of another embodiment of the present invention includes the first color separating means which separates the white light into the beam containing the red and green light and the beam containing the blue light and UV rays, the second color separating means which separates the beam containing the red and green light into the red light and the green light, and at least one optical component which reflects or transmits the blue light separated by the first color separating means. At least a part of the optical component and/or the liquid-crystal displays is made of inorganic material.

In the liquid-crystal projector of the present invention, the white light is separated into the beam containing the red and green light and the beam containing the blue light and UV rays by the first color separating means, and the UV rays are removed from the beam containing the blue light by the UV rays removing means. Accordingly, it can be reduced the deterioration of the optical components arranged in the optical path of the blue light, to lengthen the duration life of the optical system.

In the other embodiment of the present invention, the optical component which is disposed the optical path of the beam containing the blue light and the UV rays, is made of inorganic material having high resistance to the UV rays. Accordingly, it can be reduced the deterioration of the optical component.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a perspective view of a liquid-crystal projector; and

FIG. 2 is a schematic view illustrating optical structure of a projection unit of the liquid-crystal projector.

### PREFERRED EMBODIMENTS OF THE INVENTION

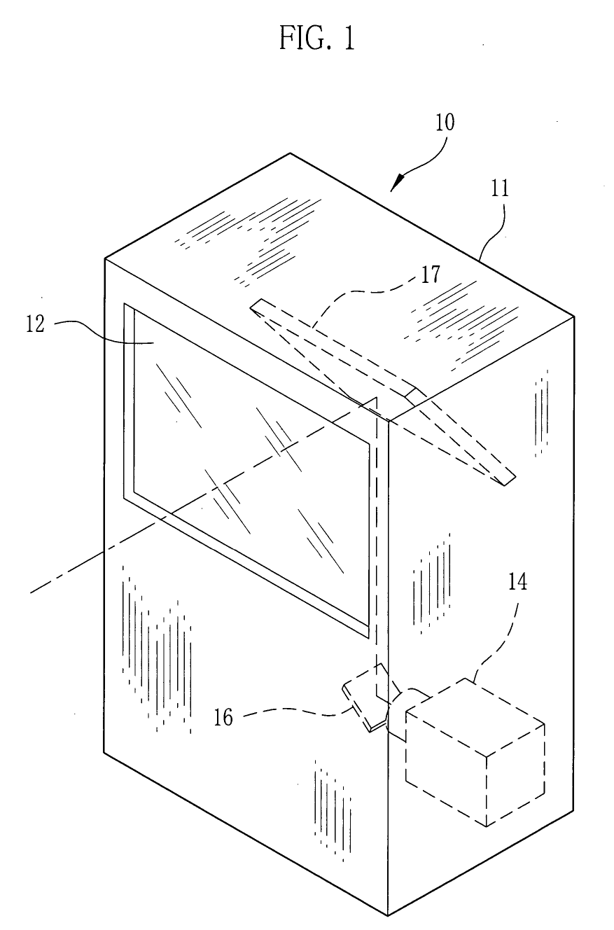

In FIG. 1, a screen 12 of diffuse transmission type is provided on front of a case 11 of a liquid-crystal projector 10. An image projected on rear side of the screen 12 is monitored from front side of the screen 12. A projection unit 14 is contained in the case 11. The image projected from the projection unit 14 is reflected by mirrors 16, 17 and focused on rear side of the screen 12. The liquid-crystal projector 10 provides a well known circuit unit including a tuner circuit and a circuit for video signal and voice signal reproduction, etc., inside the case 11. By displaying reproduction images of the video signal on liquid-crystal displays provided in the projection unit 14, the liquid-crystal projector 10 can be used for a television set having a big screen.

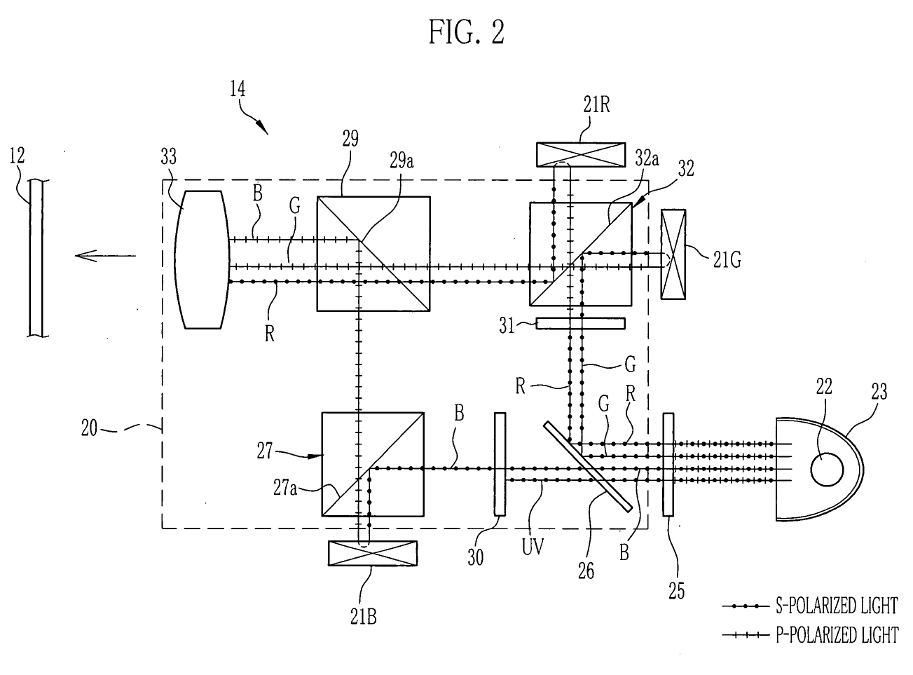

In FIG. 2, three reflective liquid-crystal displays 21B, 21G, 21R, which are corresponding to blue, green and red light respectively, are contained in the projection unit 14. A light source 22 emits illuminating light which contains the blue, green and red light (referred to simply as B, G, R respectively in FIG. 2). For example, a xenon lamp, a mercury lamp light source, etc., which are white light sources, are used as the light source 22. The illuminating light emitted from the light source 22 is reflected by a reflector 23, for forming the illuminating light to approximately parallel rays.

A polarizer 25 is disposed ahead of the light source 22. The polarizer 25 converts the blue, green, red light from the light source 22, which have not specific plane of polarization, into S-polarized light. In FIG. 2, dots and crossbars on respective lines represent polarization states of each color light. The dots represent the S-polarized light which has vertical plane of polarization, and the crossbars represent P-polarized light which has horizontal plane of polarization. Each color light passed through the polarizer 25 enters to a dichroic mirror 26.

A color separating and composing optical system 20 of the projection unit 14 includes the dichroic mirror 26, a first PBS 27, a composite prism 29, an ultraviolet rays (UV) cut filter 30, a polarization rotator 31, a second PBS 32, a project lens 33.

The dichroic mirror 26 is a first color separating means for separating the blue light from the white light, which reflects the green and red light and transmits a short wavelength light containing the blue light. As known, the wavelength of the UV rays is shorter than that of the blue light, therefore the UV rays (referred to simply as UV in FIG. 2) pass through the dichotic mirror 26 with the blue light. By separating the blue light at first by the dichroic mirror 26, the UV rays are prevented from entering the optical path of the green light and the red light.

The red and green light reflected by the dichroic mirror 26 enters to the polarization rotator 31. The polarization rotator 31 and the second PBS 32 constitute a second color separating means which separates the red light and the green light. The polarization rotator 31, which has wavelength selectivity, rotates the plane of polarization of red light 90 degrees while transmitting the red light, and does not rotate the plane of polarization while transmitting the green light. The polarization rotator 31 is made of organic materials, which has low resistance especially to UV rays. However, because the UV rays are prevented from entering the optical path of the green light and the red light as described above, the deterioration of the polarization rotator 31 is delayed.

The plane of polarization of the red light is rotated 90 degrees by the polarization rotator 31, such that the red light is converted into the P-polarized light from the S-polarized light. The red light passes through a polarizing film 32a of the second PBS 32, and enters to the liquid-crystal display 21R. The red light is converted into the S-polarized light when the red light is modulated into an image light by the liquid-crystal display 21R. The S-polarized red light outputted from the liquid-crystal display 21R is reflected by the second PBS 32, and enters to the composite prism 29.

The green light entered into the polarization rotator 31 passes through the polarization rotator 31 without being converted the polarization state, and enters to the second PBS 32. The green light is reflected by the polarizing film 32a, because the entered green light is S-polarized light. Accordingly, the red light and the green light are separated, and the separated green light enters to the liquid-crystal display 21G. The green light entered to the liquid-crystal display 21G is modulated into an image light and converted into the P-polarized light by the liquid-crystal display 21G. The P-polarized green light outputted from the liquid-crystal display 21G passes through the second PBS 32, and enters to the composite prism 29.

On the other hand, the blue light passed through the dichroic mirror 26 enters to the first PBS 27, which reflects the S-polarized light and transmits the P-polarized light. The blue light entered to the first PBS 27, which is S-polarized light, is reflected by a polarizing film 27a and enters to the liquid-crystal display 21B. The blue light entered to the liquid-crystal display 21B is modulated into an image light and converted into the P-polarized light from the S-polarized light by the liquid-crystal display 21B. The P-polarized blue light outputted from the liquid-crystal display 21B passes through the first PBS 27, and enters to the composite prism 29.

The UV cut filter 30 is disposed between the dichroic mirror 26 and the first PBS 27. The UV cut filter 30 is a filter which absorbs the UV rays and transmits other color lights, as known. As described above, the dichroic mirror 26 transmits the UV rays with the blue light. The UV cut filter 30 removes the UV rays from the optical path of the blue light, by absorbing the UV rays passes through the dichroic mirror 26. Accordingly, because optical components (for example the first PBS 27, the composite prism 29, and the liquid-crystal display 21B) disposed in the optical path of the blue light are free from the UV rays, the deterioration of the optical components by the UV rays is prevented.

There may be cases that the polarization rotator, the polarizing plate, etc., which have remarkably low durability against the UV rays, are disposed in the optical path of the blue light, resulting from design of composition of the optical system. In these cases, the UV cut filter 30 is more effective.

In a case that the optical component is disposed between the dichroic mirror 26 and the first PBS 27 additionally to the UV cut filter 30, the UV cut filter may be disposed between the dichroic mirror 26 and the optical component, so as not to enter the UV rays into the optical component.

The image lights of blue, green, and red, which enter the composite prism, are composed by a dichroic film 29a of the composite prism 29, because the dichroic film 29a reflects the blue light and transmits the green light and the red light. The composed light is projected on the screen 12 by a projection lens 33, as project light.

In the above embodiment, the UV cut filter which absorbs the UV rays is used. However, a dichroic filter which reflects the UV rays and transmits the blue light also can be used alternative to the UV cut filter.

In addition, in order to improve the durability of the optical component to the UV rays further, inorganic materials (for example glass) having high resistance to UV rays may be used for the optical component. The optical component made of the inorganic material may be used with the UV cut filter, or alternative to the UV cut filter.

As described above, it is preferable that the UV cut filter is disposed just behind the dichroic filter which is the first color separating means. However, there may be a case that the UV cut filter can not be disposed just behind the dichroic filter, because of restriction of the disposition space, etc. resulting from design of composition of the optical system. In this case, it is preferable that the optical component, which is disposed between the dichroic filter and the UV cut filter, is made of the inorganic materials.

Although the reflective liquid-crystal displays are used for the liquid-crystal projectors of the above embodiments, the present invention can be also applied to a liquid-crystal projector which uses transmissive liquid-crystal displays. In addition, the screen 12 can be removed from the liquid-crystal projector, and an external screen may be used for being projected images thereon.

Various changes and modifications are possible in the present invention and may be understood to be within the present invention.

1. A liquid-crystal projector comprising a light source for emitting white light which contains red, green and blue light, and UV rays, liquid-crystal displays which modulate the red, green and blue light respectively, and a color separating and composing means which separates the white light into the red, green and blue light, carries out the red, green and blue light to said corresponding liquid-crystal display, and composes the red, green and blue light which are emitted by said respective liquid-crystal displays, said color separating and composing means including:
a first color separating means which separates the white light into a beam containing the red and green light and a beam containing the blue light and the UV rays;
a second color separating means which separates the beam containing the red and green light into the red light and the green light; and
an UV rays removing means which removes the UV rays from the beam containing the blue light and the UV rays.

2. A liquid-crystal projector according to claim 1, wherein it is arranged in order of said first color separating means, said UV rays removing means, and said liquid-crystal display, along the optical path of the blue light, from said light source side, wherein said color separating and composing means further includes at least one optical component which reflects or transmits the blue light separated by said first color separating means, said optical component is disposed between said UV rays removing means and said liquid-crystal display, or behind said liquid-crystal display.

3. A liquid-crystal projector according to claim 1, wherein said UV rays removing means is a dicroic filter or an UV cut filter.

4. A liquid-crystal projector according to claim 1, wherein said first color separating means is a dichroic mirror, and said second color separating means are a polarization rotator and a PBS.

5. A liquid-crystal projector comprising a light source for emitting white light which contains red, green and blue light, and UV rays, liquid-crystal displays which modulate the red, green and blue light respectively, and a color separating and composing means which separates the white light into the red, green and blue light, carries out the red, green and blue light to said corresponding liquid-crystal display, and composes the red, green and blue light which are emitted by said respective liquid-crystal displays, said color separating and composing means including:
a first color separating means which separates the white light into a beam containing the red and green light and a beam containing the blue light and the UV rays;
a second color separating means which separates the beam containing the red and green light into the red light and the green light; and
at least one optical component which reflects or transmits the blue light separated by said first color separating means, wherein at least a part of said optical component and/or said liquid-crystal displays is made of inorganic material.

6. A liquid-crystal projector according to claim 5, wherein said color separating and composing means further includes an UV rays removing means which removes the UV rays from the beam containing the blue light and the UV rays.
